(19) United States
(12) Patent Application Publication
(10) Pub. No.: US 2023/0238665 A1
(43) Pub. Date: Jul. 27, 2023

(54) ELECTROCHEMICAL APPARATUS AND ELECTRICAL DEVICE

(71) Applicant: Ningde Amperex Technology Limited, Ningde (CN)

(72) Inventors: Qiuyan WENG, Ningde (CN); Yibo ZHANG, Ningde (CN); Hongmei WEI, Ningde (CN)

(73) Assignee: Ningde Amperex Technology Limited, Ningde (CN)

(21) Appl. No.: 18/191,926

(22) Filed: Mar. 29, 2023

Related U.S. Application Data
(63) Continuation of application No. PCT/CN2021/084095, filed on Mar. 30, 2021.

(51) Int. Cl. H01M 50/538; H01M 50/446

(52) U.S. Cl. CPC H01M 50/538; H01M 50/446

(57) ABSTRACT

An electrochemical apparatus includes an electrode assembly. The electrode assembly includes a first electrode plate, a first separation layer, a second electrode plate, and a second separation layer. Along a first direction, the first separation layer includes a first protruding portion extending beyond the second electrode plate, and the second separation layer includes a second protruding portion extending beyond the second electrode plate. The first protruding portion includes a first bonding area, the second protruding portion includes a second bonding area, and adhesion between the first bonding area and the second bonding area is F1, where F1≥5 N/m. Separation layers on two sides of an electrode plate are bonded to prevent the separation layers from shrinking at high temperatures or prevent the separation layers from turning inward at edges due to impact from an electrolyte when the electrochemical apparatus falls, thereby preventing a short circuit.

### CROSS REFERENCE TO RELATED APPLICATIONS

This application is the National Stage application of PCT international application: PCT/CN2021/084095 filed on Mar. 30, 2021, the disclosure of which is hereby incorporated by reference in its entirety.

### TECHNICAL FIELD

This application relates to the field of battery technologies, and specifically, to an electrochemical apparatus and an electrical device.

### BACKGROUND

Electrochemical apparatuses (for example, lithium-ion batteries) have advantages such as high voltage, small size, light weight, high specific capacity, no memory effect, no pollution, low self-discharge, and long cycle life, and therefore have been widely applied to many fields. With the wide application of electrochemical apparatuses, their performance attracts increasing attention.

In a current electrochemical apparatus, a separator is disposed between a positive electrode plate and a negative electrode plate. One of main functions of the separator is to separate the positive electrode plate from the negative electrode plate, and prevent electrons from passing freely, but let ions in an electrolyte pass freely. However, the separator shrinks at high temperatures (>110° C.), causing local direct contact of the positive electrode plate and the negative electrode plate, which leads to a short circuit, posing safety hazards. In addition, when the electrochemical apparatus falls, impact from the electrolyte may cause the separator to turn inward at edges, also causing local direct contact of the positive electrode plate and the negative electrode plate, which leads to a short circuit, posing safety hazards.

### SUMMARY

A first aspect of this application provides an electrochemical apparatus, including an electrode assembly. The electrode assembly includes a first electrode plate, a first separation layer, a second electrode plate, and a second separation layer. The first separation layer is located between the first electrode plate and the second electrode plate, and the second electrode plate is located between the first separation layer and the second separation layer. Along a first direction, the first separation layer includes a first protruding portion extending beyond the second electrode plate, and the second separation layer includes a second protruding portion extending beyond the second electrode plate. The first protruding portion includes a first bonding area, the second protruding portion includes a second bonding area, and adhesion between the first bonding area and the second bonding area is F1, where F1≥5 N/m.

In some embodiments, along a second direction perpendicular to the first direction, a length of the first bonding area is L1, and a length of the first protruding portion is L2, where 0.1≤L1/L2≤1, or optionally, 0.5≤L1/L2≤0.75.

In some embodiments, the first direction is a width direction of the second electrode plate, and the second direction is a length direction of the second electrode plate.

In some embodiments, a width of the first bonding area is 0.5 mm to 20 mm, or optionally, 0.5 mm to 2 mm.

In some embodiments, the electrode assembly is in a stacked structure, the electrode assembly further includes a third separation layer and a third electrode plate, the second separation layer is located between the second electrode plate and the third electrode plate, and the third electrode plate is located between the second separation layer and the third separation layer; and along the first direction, the third separation layer includes a third protruding portion extending beyond the third electrode plate, the second separation layer includes a fourth protruding portion extending beyond the third electrode plate, the third protruding portion includes a third bonding area, and the fourth protruding portion includes a fourth bonding area, where the third bonding area is bonded with the fourth bonding area.

In some embodiments, the electrode assembly is in a wound structure; along a winding thickness direction of the electrode assembly, the first electrode plate includes a first layer portion and a third layer portion that are adjacent to each other, the second electrode plate includes a second layer portion and a fourth layer portion that are adjacent to each other, the first separation layer includes a first separation portion and a third separation portion that are adjacent to each other, the second separation layer includes a second separation portion and a fourth separation portion that are adjacent to each other, and the first layer portion, the first separation portion, the second layer portion, the second separation portion, the third layer portion, the third separation portion, the fourth layer portion, and the fourth separation portion are arranged in sequence; and along the first direction, the third separation portion includes a third protruding portion extending beyond the third layer portion, the second separation portion includes a fourth protruding portion extending beyond the third layer portion, the third protruding portion includes a third bonding area, and the fourth protruding portion includes a fourth bonding area, where the third bonding area is bonded with the fourth bonding area.

In some embodiments, adhesion between the third bonding area and the fourth bonding area is F2, where F2<5 N/m, or optionally, F2≤2 N/m.

In some embodiments, the first electrode plate and the third electrode plate are positive electrode plates, and the second electrode plate is a negative electrode plate.

In some embodiments, along the first direction, the second electrode plate includes a first structural portion extending beyond the third electrode plate, and the fourth bonding area is located on a surface of the first structural portion.

In some embodiments, along the first direction, the second layer portion includes a first structural portion extending beyond the third layer portion, and the fourth bonding area is located on a surface of the first structural portion.

In some embodiments, along the first direction, the second separation layer includes a first area located on a surface of the third electrode plate and a second area located on the surface of the first structural portion, a thickness of the first area is H1, a thickness of the second area is H2, and a thickness of the third electrode plate is H3, where ½≤(H2−H1)/H3≤3/2.

In some embodiments, along the first direction, the second separation portion includes a first area located on a surface of a third layer portion, and a second area located on the surface of the first structural portion, a thickness of the first area is H1, a thickness of the second area is H2, and a thickness of the third layer portion is H3, where ½≤(H2−H1)/H3≤3/2.

In some embodiments, a porosity of each of the first separation layer, the second separation layer, and the third separation layer is independently α, where 30%≤α≤95%.

In some embodiments, an aperture of each of the first separation layer, the second separation layer, and the third separation layer is independently Φ, where 10 nm≤Φ≤5 μm.

In some embodiments, a thickness of each of the first separation layer, the second separation layer, and the third separation layer is independently H, where 1 μm≤H≤20 μm.

In some embodiments, at least one of the first separation layer, the second separation layer, or the third separation layer includes polymer fibers, and optionally, further includes particles, where the particles include at least one of inorganic substance or organic substance.

In some embodiments, at least one of the first separation layer, the second separation layer, or the third separation layer includes a first layer and a second layer disposed on the first layer, where the first layer includes the polymer fibers, and the second layer includes the particles.

In some embodiments, the polymer fibers include at least one of polyvinylidene fluoride, polyimide, polyamide, polyacrylonitrile, polyethylene glycol, polyethylene oxide, polyphenylene oxide, polypropylene carbonate, polymethyl methacrylate, polyethylene glycol terephthalate, poly(vinylidene fluoride-hexafluoropropylene), poly(vinylidene fluoride-chlorotrifluoroethylene), or derivatives thereof.

In some embodiments, the inorganic substance includes at least one of hafnium oxide, strontium titanate, tin dioxide, cesium oxide, magnesium oxide, nickel oxide, calcium oxide, barium oxide, zinc oxide, zirconium oxide, yttrium oxide, aluminum oxide, titanium oxide, silicon dioxide, alumina hydrate, magnesium hydroxide, aluminum hydroxide, lithium phosphate, lithium titanium phosphate, lithium aluminum titanium phosphate, lithium lanthanum titanate, lithium germanium thiophosphate, lithium nitride, SiS₂ glass, P₂S₅ glass, lithium oxide, lithium fluoride, lithium hydroxide, lithium carbonate, lithium metaaluminate, lithium germanium phosphorous sulfur ceramics, or garnet ceramics.

In some embodiments, the organic substance includes at least one of polyvinylidene fluoride, polyimide, polyamide, polyacrylonitrile, polyethylene glycol, polyethylene oxide, polyphenylene oxide, polypropylene carbonate, polymethyl methacrylate, polyethylene glycol terephthalate, poly(vinylidene fluoride-hexafluoropropylene), poly(vinylidene fluoride-chlorotrifluoroethylene), or derivatives thereof.

A second aspect of this application provides an electrical device, including the electrochemical apparatus according to any one of the foregoing embodiments.

In the electrochemical apparatus and electrical device of this application, separation layers located on two sides of one electrode plate are bonded to each other, which helps prevent the separation layers from turning inward, reduce shrinkage at high temperatures, and reduce a risk of short circuiting due to contact of the positive electrode plate and the negative electrode plate. In addition, the adhesion satisfies F1≥5 N/m, which can reduce a risk that edges of the separation layers are gradually separated during long-term immersion in an electrolyte due to small adhesion, thereby ensuring long-term safety of the electrochemical apparatus.

### BRIEF DESCRIPTION OF DRAWINGS

FIG. 1 is a schematic structural diagram of bonding between separation layers in an electrochemical apparatus according to this application;

FIG. 2 is a schematic structural diagram of bonding between separation layers in an electrochemical apparatus according to this application;

FIG. 3 is a schematic structural diagram of an electrode assembly in a wound structure according to an embodiment of this application;

FIG. 4 is a schematic structural diagram of bonding between separation layers in an electrochemical apparatus according to this application;

FIG. 5 is a schematic structural diagram of bonding between separation layers in an electrochemical apparatus according to this application;

FIG. 6 is a schematic flowchart of a method for preparing a separation layer according to an embodiment of this application;

FIG. 7 is a micro schematic structural diagram of a separation layer according to an embodiment of this application; and

FIG. 8 is a micro schematic structural diagram of a separation layer according to another embodiment of this application.

### DETAILED DESCRIPTION

To make the objectives, technical solutions, and advantages of this application clearer, the following clearly describes the technical solutions of this application with reference to the embodiments and the accompanying drawings in the embodiments. Apparently, the described embodiments are merely some rather than all of the embodiments. Based on the embodiments of this application, the following embodiments and technical features thereof may be combined if there is no collision.

It should be understood that, in the descriptions of the embodiments of this application, directions or location relationships indicated by the terms such as “center”, “longitudinal”, “lateral”, “length”, “width”, “thickness”, “up”, “down”, “front”, “rear”, “left”, “right”, “vertical”, “horizontal”, “top”, “bottom”, “inside”, “outside”, “clockwise”, and “counterclockwise” are based on the directions or the location relationships shown in the accompanying drawings, and are merely intended to describe the technical solutions in the corresponding embodiments of this application and simplify the descriptions, but not intended to indicate or imply that an apparatus or an element shall have a specific direction or be formed and operated in a specific direction, and therefore cannot be understood as a limitation on this application.

It is considered that in an existing electrochemical apparatus, edges of a separation layer are prone to turning inward and shrinkage at high temperatures, which causes a short circuit due to contact between a positive electrode plate and a negative electrode plate. In view of this, the embodiments of this application provide an electrochemical apparatus, in which separation layers located on two sides of a same electrode plate are bonded to each other, to prevent the separation layers from turning inward, reduce shrinkage at high temperatures, and reduce a risk of short circuiting due to contact of a positive electrode plate and a negative electrode plate.

In a specific scenario, the electrochemical apparatus in the embodiments of this application includes but is not limited to all types of primary batteries and secondary batteries. Preferably, the electrochemical apparatus may be a lithium-ion battery, including but not limited to a lithium metal secondary battery, a lithium-ion secondary battery, a lithium polymer secondary battery, and a lithium-ion polymer secondary battery. The electrochemical apparatus in the embodiments of this application may exist in a form of a battery cell or a battery module.

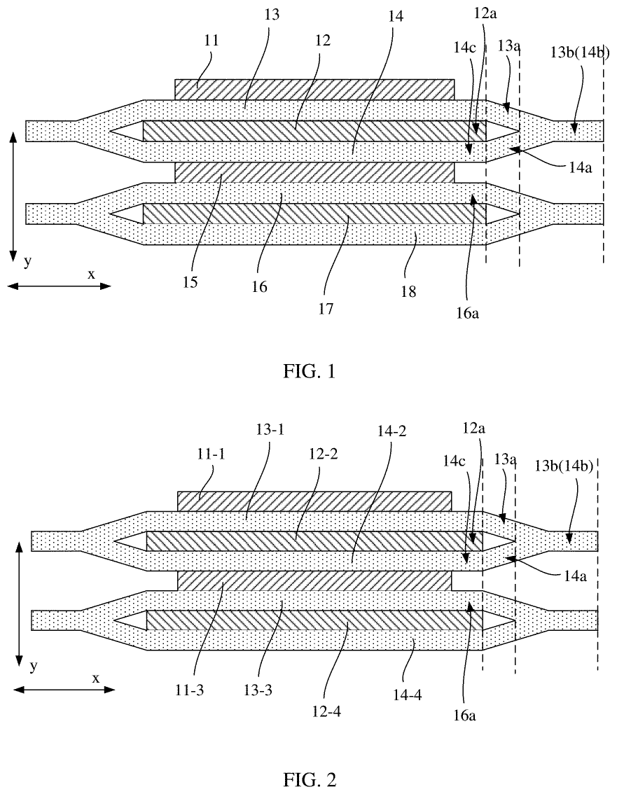

Referring to FIG. 1, an electrode assembly includes a first electrode plate 11, a second electrode plate 12, a first separation layer 13, and a second separation layer 14. The first separation layer 13 is located between the first electrode plate 11 and the second electrode plate 12, and the second electrode plate 12 is located between the first separation layer 13 and the second separation layer 14.

According to a design of the electrochemical apparatus with positive and negative polarities, one of the first electrode plate 11 and the second electrode plate 12 is a positive electrode plate, and the other is a negative electrode plate. For ease of description, the embodiments in this specification is described by using an example in which the first electrode plate 11 is a positive electrode plate and the second electrode plate 12 is a negative electrode plate.

Positive Electrode Plate

The positive electrode plate may include a positive electrode current collector and a positive electrode active material layer formed on two surfaces of the positive electrode current collector. The positive electrode active material layer contains a positive electrode active material.

A material of the positive electrode current collector is not particularly limited, and may be any material suitable for serving as the positive electrode current collector. In some examples, the positive electrode current collector includes but is not limited to metal materials such as aluminum (Al), stainless steel, nickel (Ni), titanium (Ti), and tantalum (Ta), and carbon materials such as carbon cloth and carbon paper.

In some embodiments, there may be one or more positive electrode active material layers, and each of a plurality of positive electrode active material layers contains a same positive electrode active material or different positive electrode active materials. The positive electrode active material is a material capable of reversibly intercalating and deintercalating metal ions such as lithium ions. Preferably, a chargeable capacity of the positive electrode active material layer is less than a discharge capacity of a negative electrode active material layer to prevent lithium metal from precipitating on a negative electrode plate during charging.

A type of the positive electrode active material is not limited in the embodiments of this application provided that metal ions (for example, lithium ions) can be electrochemically occluded and released. In some embodiments, the positive electrode active material may be a material containing lithium and at least one transition metal. Examples of the positive electrode active material may include but are not limited to a lithium transition metal composite oxide and a lithium-containing transition metal phosphate compound. The transition metal includes but is not limited to vanadium (V), titanium (Ti), chromium (Cr), manganese (Mn), ferrum (Fe), cobalt (Co), nickel (Ni), cuprum (Cu), and the like.

A material with a composition different from that of the positive electrode active material may be attached to a surface of the positive electrode active material. The attached material includes but is not limited to: oxides such as aluminum oxide, silicon dioxide, titanium dioxide, zirconium oxide, magnesium oxide, calcium oxide, boron oxide, antimony oxide, and bismuth oxide; sulfates such as lithium sulfate, sodium sulfate, potassium sulfate, magnesium sulfate, calcium sulfate, and aluminum sulfate; carbonates such as lithium carbonate, calcium carbonate, and magnesium carbonate; carbon; and the like.

A method for attaching the material to the surface of the positive electrode active material layer includes but is not limited to: a method for dissolving or suspending the attached material in a solvent to infiltrate into the positive electrode active material, and then performing drying; a method for dissolving or suspending the attached material in a solvent to infiltrate into the positive electrode active material, and then performing heating or the like to implement reaction of the attached material; a method for adding the attached material to a precursor of the positive electrode active material while performing sintering; and the like. In an example of attaching carbon, a method of mechanical attachment by using a carbon material (for example, activated carbon) may be used.

Attaching the material to the surface of the positive electrode active material layer can inhibit oxidation reaction of an electrolyte on the surface of the positive electrode active material layer, which helps increase a service life of the electrochemical apparatus. In the descriptions of this specification, the positive electrode active material layer and the material attached to the surface thereof may also be referred to as a positive electrode active material layer.

Negative Electrode Plate

The negative electrode plate may include a negative electrode current collector and a negative electrode active material layer formed on two surfaces of the negative electrode current collector. The negative electrode active material layer contains a negative electrode active material.

In some embodiments, the negative electrode current collector includes but is not limited to a metal foil, a metal film, a metal mesh, a stamped metal plate, a foamed metal plate, a conductive resin plate, and the like.

In some embodiments, there may be one or more negative electrode active material layers, and each of a plurality of negative electrode active material layers may contain a same negative electrode active material or different negative electrode active materials. The negative electrode active material is any material capable of reversibly intercalating and deintercalating metal ions such as lithium ions.

A type of the negative electrode active material is not limited in the embodiments of this application provided that metal ions can be electrochemically occluded and released. In some examples, the negative electrode active material includes but is not limited to carbon materials such as graphite, hard carbon, and soft carbon, silicon (Si), silicon-containing compounds such as silicon oxides represented by SiOx (0<x<2), lithium metal, metal that forms an alloy with lithium and alloys thereof, amorphous compounds mainly composed of oxides such as tin dioxide, and lithium titanate.

Still referring to FIG. 1, a width of the negative electrode plate is greater than that of the positive electrode plate, and along a first direction (a width direction of the negative electrode plate, namely, a direction indicated by an arrow x in FIG. 1), the negative electrode plate extends beyond the positive electrode plate to produce a first structural portion 12a.

Separation Layer

Both the first separation layer 13 and the second separation layer 14 are referred to as separation layers, and are disposed between the positive electrode plate and the negative electrode plate to separate the positive electrode plate from the negative electrode plate, and prevent electrons in the electrochemical apparatus from passing freely, but let ions in the electrolyte pass freely. The positive electrode plate, the negative electrode plate, the first separation layer 13, and the second separation layer 14 are wound or stacked to form an electrode assembly of the electrochemical apparatus.

Along the first direction (namely, the direction indicated by the arrow x in FIG. 1), the first separation layer 13 includes a first protruding portion 13a extending beyond the second electrode plate 12, and the second separation layer 14 includes a second protruding portion 14a extending beyond the second electrode plate 12. The first protruding portion 13a includes a first bonding area 13b, the second protruding portion 14a includes a second bonding area 14b, and the first bonding area 13b is bonded with the second bonding area 14b.

On two sides of the second electrode plate 12, the first separation layer 13 and the second separation layer 14 are bonded to each other, which can reduce shrinkage of the two separation layers in a high temperature environment, and reduce a risk of short circuiting due to contact of the positive electrode plate and the negative electrode plate. In addition, in a vibration environment, for example, upon falling, a probability that the separation layers turn inward due to impact from the electrolyte is reduced, and a risk of short circuiting due to contact of the positive electrode plate and the negative electrode plate can also be reduced.

In addition, adhesion F1 between the first bonding area 13b and the second bonding area 14b is greater than or equal to 5 N/m. The adhesion is within the foregoing range, which can reduce a risk that edges of the separation layers are gradually separated during long-term immersion in the electrolyte due to small adhesion, thereby ensuring long-term safety of the electrochemical apparatus.

In some examples, along a second direction (a length direction of the second electrode plate 12), the second direction is perpendicular to the first direction, and a length L1 of the first bonding area 13b and a length L2 of the first protruding portion 13a can satisfy the following relationship: 0.1≤L1/L2≤1, or preferably, 0.5≤L1/L2≤0.75. L1/L2 is within the foregoing range, and a length ratio of the bonding area is appropriate, which can inhibit shrinkage and inward turning of an unbonded part of the edges of the separation layers, thereby reducing a risk of a short circuit due to contact between the positive electrode plate and the negative electrode plate.

In some specific scenarios, a width of the first bonding area 13b is 0.5 mm to 20 mm. Preferably, the width of the first bonding area 13b is 0.5 mm to 2 mm.

The length and the width of the bonding area (namely, the first bonding area 13b) are within the foregoing ranges, which can ensure bonding strength and safety of the electrochemical apparatus.

Referring to FIG. 1 and FIG. 4, when the electrode assembly is in a stacked structure, the electrode assembly further includes a third electrode plate 15, a third separation layer 16, a fourth electrode plate 17, and a fourth separation layer 18. The third electrode plate 15 and the first electrode plate 11 have a same polarity. For example, both are positive electrode plates. The fourth electrode plate 17 and the second electrode plate 12 have a same polarity. For example, both are negative electrode plates.

Referring to FIG. 4, the second separation layer 14 is located between the second electrode plate 12 and the third electrode plate 15, and the third electrode plate 15 is located between the second separation layer 14 and the third separation layer 16. Along the first direction, namely, a direction indicated by an arrow x in FIG. 4, the third separation layer 16 includes a third protruding portion 16a extending beyond the third electrode plate 15, and the second separation layer 14 includes a fourth protruding portion 14c extending beyond the third electrode plate 15, where the fourth protruding portion 14c includes the second protruding portion 14a and a part of the second separation layer 14 that is located on a surface of the first structural portion 12a, the third protruding portion 16a includes a third bonding area, and the fourth protruding portion 14c includes a fourth bonding area. In some embodiments, along the first direction, the second electrode plate 12 includes a first structural portion 12a, namely, A/C overhang, that extends beyond the third electrode plate 15, and the fourth bonding area may be located on the surface of the first structural portion 12a.

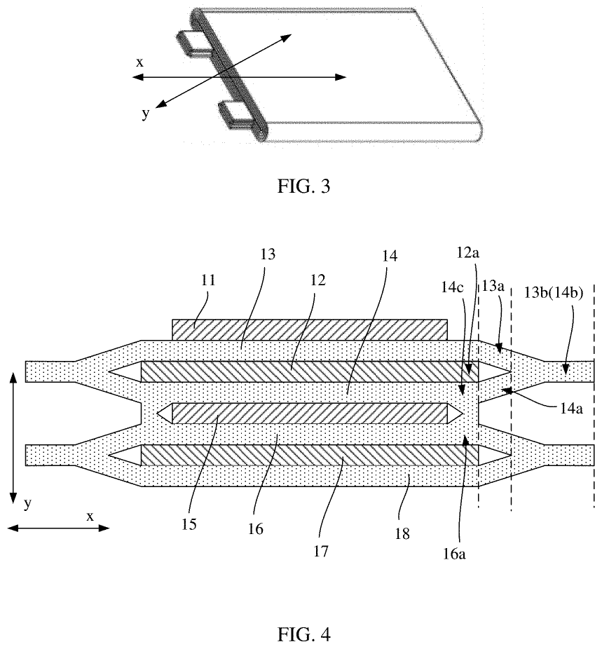

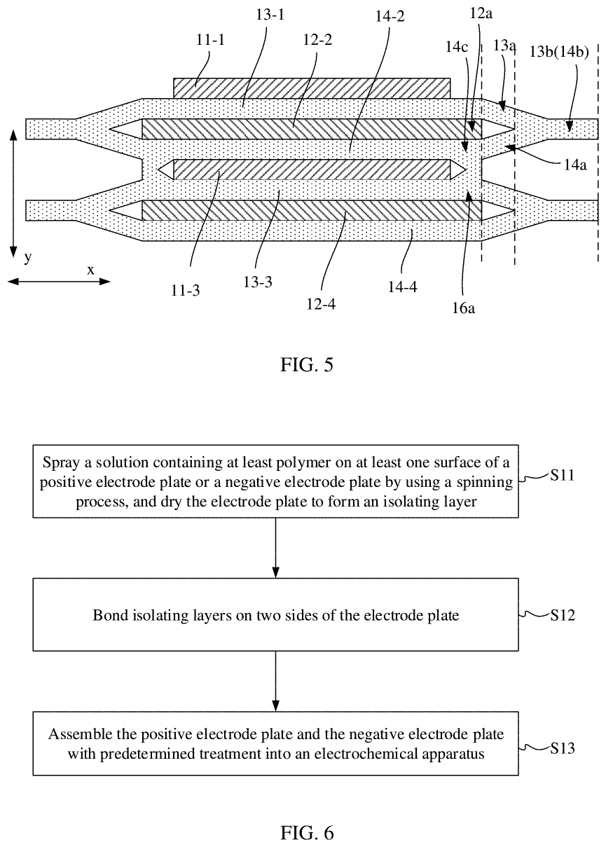

Referring to FIG. 2, FIG. 3, and FIG. 5, when the electrode assembly is in a wound structure, along a winding thickness direction y of the electrode assembly, the first electrode plate 11 includes a first layer portion 11-1 and a third layer portion 11-3 that are adjacent to each other, the second electrode plate 12 includes a second layer portion 12-2 and a fourth layer portion 12-4 that are adjacent to each other, the first separation layer 13 includes a first separation portion 13-1 and a third separation portion 13-3 that are adjacent to each other, and the second separation layer 14 includes a second separation portion 14-2 and a fourth separation portion 14-4 that are adjacent to each other, where the first layer portion 11-1, the first separation portion 13-1, the second layer portion 12-2, the second separation portion 14-2, the third layer portion 11-3, the third separation portion 13-3, the fourth layer portion 12-4, and the fourth separation portion 14-4 are arranged in sequence. To be specific, the first separation portion 13-1 is located between the first layer portion 11-1 and the second layer portion 12-2, the second layer portion 12-2 is located between the first separation portion 13-1 and the second separation portions 14-2, the second separation portion 14-2 is located between the second layer portion 12-2 and the third layer portion 11-3, the third layer portion 11-3 is located between the second separation portion 14-2 and the third separation portion 13-3, the third separation portion 13-3 is located between the third layer portion 11-3 and the fourth layer portion 12-4, and the fourth layer portion 12-4 is located between the third separation portion 13-3 and the fourth separation portion 14-4. FIG. 2 and FIG. 5 are cross-sectional views obtained through observation in a direction perpendicular to an x-y plane.

Still referring to FIG. 5, along the first direction, namely, a direction indicated by an arrow x in FIG. 5, the third separation portion 13-3 includes a third protruding portion 16a extending beyond the third layer portion 11-3, and the second separation portion 14-2 includes a fourth protruding portion 14c extending beyond the third layer portion 11-3, where the third protruding portion 16a includes a third bonding area, and the fourth protruding portion 14c includes a fourth bonding area. In some embodiments, along the first direction, the second layer portion 12-2 includes the first structural portion 12a, namely, A/C overhang, that extends beyond the third layer portion 11-3, and the fourth bonding area may be located on the surface of the first structural portion 12a.

As shown in FIG. 4 and FIG. 5, the third bonding area is bonded with the fourth bonding area. On two sides of the third electrode plate 15 and/or the third layer portion 11-3, the second separation layer 14 and the third separation layer 16 are bonded to each other, or the second separation portion 14-2 and the third separation portion 13-3 are bonded to each other, which can reduce shrinkage in a high temperature environment, and reduce a risk of short circuiting due to contact of the positive electrode plate and the negative electrode plate. In addition, in a vibration environment, for example, upon falling, a probability of inward turning due to impact from the electrolyte is reduced, and a risk of short circuiting due to contact of the positive electrode plate and the negative electrode plate can also be reduced.

In some examples, adhesion between the third bonding area and the fourth bonding area is F2, where F2<5 N/m, or preferably, F2≤2 N/m.

In some examples, along the first direction, the second separation layer 14 includes a first area located on a surface of the third electrode plate 15 and a second area located on the surface of the first structural portion 12a, a thickness of the first area is H1, a thickness of the second area is H2, and a thickness of the third electrode plate 15 is H3, where ½≤(H2−H1)/H3≤3/2. In some examples, along the first direction, the second separation portion 14-2 includes a first area located on a surface of the third layer portion 11-3 and a second area located on the surface of the first structural portion 12a, a thickness of the first area is H1, a thickness of the second area is H2, and a thickness of the third layer portion 11-3 is H3, where ½≤(H2−H1)/H3≤3/2, thereby ensuring bonding between the third protruding portion 16a and the fourth protruding portion 14c. A thickness may be measured by using a commonly used testing method in the field. For example, a picture of a cross section is taken by using a scanning electronic microscope (SEM) to measure a thickness of each part.

It should be understood that the foregoing bonding manner of the separation layers is only an example, and a bonding manner of separation layers is not limited in the embodiments of this application. For example, separation layers on two sides of electrode plates with a same polarity and at different layers are bonded in different manners. For another example, separation layers are bonded in different manners on two sides of a same electrode plate. In addition, as shown in FIG. 1 and FIG. 2, the first electrode plate 11 and the third electrode plate 15 may be positive electrode plates, and the second electrode plate 12 is a negative electrode plate.

The first separation layer 13, the second separation layer 14, and the third separation layer 16 each may be an independent structural layer. To be specific, a porosity α of each is independent, an aperture Φ of each is independent, and a thickness H of each is independent. In some specific scenarios, 30%≤α≤95%, 10 nm≤Φ≤5 μm, and 1 μm≤H≤20 μm, which helps ensure that ions in the electrolyte pass freely while electrons cannot pass freely.

The embodiments of this application further provide a method for preparing a separation layer, to prepare at least one of the first separation layer 13, the second separation layer 14, or the third separation layer 16. The following describes the method for preparing a separation layer with reference to FIG. 6 by using an example in which a material of the separation layer includes polymer fibers.

S11: Spray a solution containing at least polymer on at least one surface of a positive electrode plate or a negative electrode plate by using a spinning process, and dry the electrode plate to form a separation layer.

S12: Bond separation layers on two sides of the electrode plate.

S13: Assemble the positive electrode plate and the negative electrode plate with predetermined treatment into an electrochemical apparatus.

A preparation process and a material of the positive electrode plate and the negative electrode plate are not limited in this embodiment of this application.

In some examples, graphite (Graphite) as a negative electrode active material, conductive carbon black (Super P), and styrene-butadiene rubber (SBR) may be mixed at a weight ratio of 96:1.5:2.5, and deionized water was added to prepare a slurry with a solid content of 0.7. The slurry was stirred evenly and then evenly applied on a surface of a negative electrode current collector (for example, a copper foil). The material was dried at 110° C. to obtain a negative electrode active material layer. Then another negative electrode active material layer was formed on the other surface of the negative electrode current collector by using the same process. Further, cutting was performed and tabs were welded to obtain the negative electrode plate.

Lithium cobalt oxide (LiCoO₂) as a positive electrode active material, conductive carbon black, and polyvinylidene fluoride (PVDF) were mixed at a weight ratio of 97.5:1.0:1.5, and N-methylpyrrolidone (NMP) was added to prepare a slurry with a solid content of 0.75. The slurry was stirred evenly and then evenly applied on a positive electrode current collector (for example, an aluminum foil). The material was dried at 90° C. to obtain a positive electrode active material layer. Then another positive electrode active material layer was formed on the other surface of the positive electrode current collector by using the same process. Further, cutting was performed and tabs were welded to obtain the positive electrode plate.

A type of the polymer fibers is not limited in this embodiment of this application either. In some scenarios, the polymer fibers include, but are not limited to, at least one of the following: polyvinylidene fluoride, polyimide, polyamide, polyacrylonitrile, polyethylene glycol, polyethylene oxide, polyphenylene oxide, polypropylene carbonate, polymethyl methacrylate, polyethylene glycol terephthalate, poly(vinylidene fluoride-hexafluoropropylene), poly(vinylidene fluoride-chlorotrifluoroethylene), or derivatives thereof.

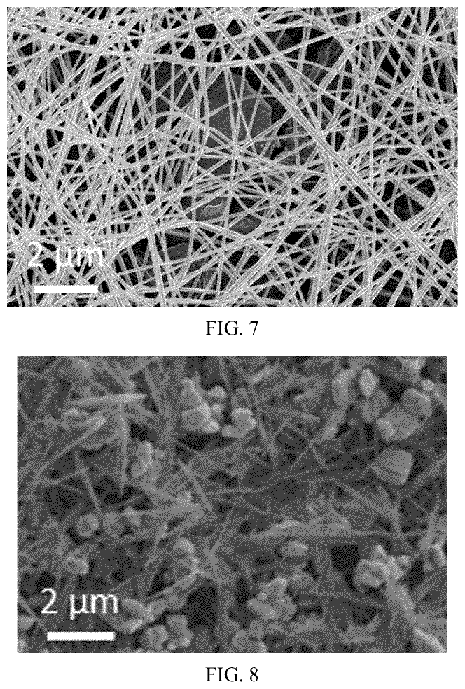

In this application, the separation layer may be formed by the polymer fibers. As shown in FIG. 7, the separation layer is a polymer fiber layer with an aperture and a porosity that allow reactive ions such as lithium ions to pass.

A structural layer formed by the polymer fibers, namely, the polymer fiber layer, may have an excessively large aperture and porosity. Therefore, the separation layer may be further provided with particles, as shown in FIG. 8. The particles make the aperture and porosity of the separation layer meet predetermined requirements.

In some embodiments, the particles may be provided on the polymer fiber layer.

In some other embodiments, the particles may be provided on the polymer fiber layer. To be specific, the separation layer includes a two-layer structure, where a first layer is the polymer fiber layer, and a second layer is a particle layer.

The particle layer (namely, the second layer) has a porosity of α0, an aperture of Φ0, a thickness of H0, a resistivity of σ, and an ion conductivity of a, which meet at least one of the following conditions:

10%≤α0≤40%; (a)

0.1 nm≤Φ0≤1 μm; (b)

0.1 μm≤H0≤20 μm; (c)

ρ>107 Ωm; and (d)

10⁻² S/cm≤σ≤10⁻⁸ S/cm. (e)

The porosity α0, the aperture Φ0, and the thickness H0 of the particle layer (namely, the second layer) are within the foregoing ranges, which can help ensure free passage of reactive ions such as lithium ions in an electrolyte.

In some examples, a material of the particles includes at least one of inorganic substance or organic substance.

The inorganic substance includes at least one of the following: hafnium oxide, strontium titanate, tin dioxide, cesium oxide, magnesium oxide, nickel oxide, calcium oxide, barium oxide, zinc oxide, zirconium oxide, yttrium oxide, aluminum oxide, titanium oxide, silicon dioxide, alumina hydrate, magnesium hydroxide, aluminum hydroxide, lithium phosphate, lithium titanium phosphate, lithium aluminum titanium phosphate, lithium lanthanum titanate, lithium germanium thiophosphate, lithium nitride, SiS₂ glass, P₂S₅ glass, lithium oxide, lithium fluoride, lithium hydroxide, lithium carbonate, lithium metaaluminate, lithium germanium phosphorous sulfur ceramics, or garnet ceramics.

The organic substance includes at least one of the following: polyvinylidene fluoride, polyimide, polyamide, polyacrylonitrile, polyethylene glycol, polyethylene oxide, polyphenylene oxide, polypropylene carbonate, polymethyl methacrylate, polyethylene glycol terephthalate, poly(vinylidene fluoride-hexafluoropropylene), poly(vinylidene fluoride-chlorotrifluoroethylene), or derivatives thereof.

The separation layer may be formed on one or two surfaces of the positive electrode plate, and may also be formed on one or two surfaces of the negative electrode plate. This is not limited in this embodiment of this application.

Another embodiment of this application provides an electrical device, including the electrochemical apparatus according to any one of the foregoing embodiments.

The electrical device may be implemented in various specific forms, for example, electronic products such as an unmanned aerial vehicle, an electric vehicle, an electric cleaning tool, an energy storage product, an electromobile, an electric bicycle, or an electric navigation tool. In a practical scenario, the electrical device includes but is not limited to a notebook computer, a pen-input computer, a mobile computer, an e-book player, a portable phone, a portable fax machine, a portable copier, a portable printer, a headset, a video recorder, a liquid crystal display television, a portable cleaner, a portable CD player, a mini disc, a transceiver, an electronic notebook, a calculator, a memory card, a portable recorder, a radio, a backup power supply, a motor, an automobile, a motorcycle, an assisted bicycle, a bicycle, a lighting fixture, a toy, a game console, a clock, an electric tool, a flashlight, a camera, a large household storage battery, a lithium-ion capacitor, and the like.

It can be understood by a person skilled in the art that the structure according to the embodiments of this application can also be applied to fixed electrical devices in addition to elements specially used for mobile purposes.

Because the electrical device has the electrochemical apparatus according to any one of the foregoing embodiments, the electrical device can produce beneficial effects of the electrochemical apparatus according to the corresponding embodiment.

Without more restrictions, an element defined by the statement “including a . . . ” does not exclude existence of other same elements in a process, a method, an article, or an apparatus that includes the element. In addition, in different embodiments, components, features, or elements with a same name may have a same meaning or different meanings, and their specific meanings need to be determined based on their interpretations in the specific embodiment or further with reference to the context in the specific embodiment.

In addition, although the terms “first, second, third”, and the like are used to describe various types of information in this specification, the information should not be limited to the terms. The terms are only used to distinguish between information of the same type. As used in this specification, singular forms “a”, “an”, and “the” are intended to also include plural forms. The terms “or” and “and/or” are interpreted as inclusive, or mean any one or any combination. An exception to this definition occurs only when a combination of elements, functions, steps, or operations is inherently mutually exclusive in some ways.

The following describes the technical solutions of this application as examples by using specific embodiments.

### Example 1

(1) Prepare a negative electrode plate: graphite as a negative electrode active material, conductive carbon black (Super P), and styrene-butadiene rubber (SBR) were mixed at a weight ratio of 96:1.5:2.5, and deionized water was added to prepare a slurry with a solid content of 0.7. The slurry was well stirred and then applied on a surface of a negative electrode current collector copper foil. The material was dried at 110° C. to obtain a negative electrode active material layer. Then another negative electrode active material layer was formed on the other surface of the negative electrode current collector by using the same process. Further, cutting was performed and tabs were welded to obtain the negative electrode plate.

(2) Prepare a positive electrode plate: lithium cobalt oxide (LiCoO₂) as a positive electrode active material, conductive carbon black (Super P), and polyvinylidene fluoride (PVDF) were mixed at a weight ratio of 97.5:1.0:1.5, and N-methylpyrrolidone (NMP) was added as a solvent to prepare a slurry with a solid content of 0.75. The slurry was well stirred and then applied on a positive electrode current collector aluminum foil. The material was dried at 90° C. to obtain a positive electrode active material layer. Then another positive electrode active material layer was formed on the other surface of the positive electrode current collector by using the same process. Further, cutting was performed and tabs were welded to obtain the positive electrode plate.

(3) Prepare a separation layer: 95% polyvinylidene fluoride, 4.5% acrylonitrile, and 0.5% boron trifluoride were dispersed in a solvent in which a weight ratio of dimethylformamide to acetone was 7:3, and the slurry was evenly stirred until a viscosity was stable, to obtain a solution A with a mass fraction of 25%. On a surface of the negative electrode plate, a polymer fiber layer was prepared by using the solution A as a raw material through an electrospinning process. Then a polymer fiber layer was prepared on the other surface of the negative electrode plate by using the same process. The polymer fiber layers on two sides were controlled to extend beyond a width of the negative electrode plate in a width direction of the negative electrode plate, so that a width W of a bonding area was 0.5 mm, and a proportion L1/L2 of a length of the bonding area in a total length by which the polymer fiber layer extended beyond the negative electrode plate was 10%. Then the solvent was removed through vacuum drying at 40° C., followed by increasing temperature to 80° C. and performing heat treatment for 6 hours to complete a cross-linking process, to obtain a negative electrode plate with separation layers on both sides.

(4) Prepare an electrolyte

In a dry argon environment, as organic solvents, ethylene carbonate (EC), ethyl methyl carbonate (EMC), and diethyl carbonate (DEC) were firstly mixed at a mass ratio of 30:50:20, and then lithium salt lithium hexafluorophosphate (LiPF₆) was added for dissolution. The mixture was evenly mixed to obtain an electrolyte with a LiPF₆ concentration of 1.15 mol/L.

(5) Prepare a lithium-ion battery: the foregoing positive electrode plate and the foregoing negative electrode plate integrating the separation layers were stacked and wound, placed them in an outer packaging foil, and performed operations such as the liquid injection and packaging to obtain the lithium-ion battery.

A difference between Example 2 and Example 1 lies in that L1/L2 is controlled to be equal to 50%.

A difference between Example 3 and Example 1 lies in that L1/L2 is controlled to be equal to 75%.

A difference between Example 4 and Example 1 lies in that L1/L2 is controlled to be equal to 100%.

A difference between Example 5 and Example 2 lies in that W is controlled to be equal to 0.7 mm.

A difference between Example 6 and Example 5 lies in that W is controlled to be equal to 1 mm.

A difference between Example 7 and Example 5 lies in that W is controlled to be equal to 5 mm.

A difference between Example 8 and Example 5 lies in that W is controlled to be equal to 10 mm.

A difference between Example 9 and Example 5 lies in that W is controlled to be equal to 15 mm.

A difference between Example 10 and Example 5 lies in that, along the width direction of the negative electrode plate, a thickness H2 of an area of the separation layer extending beyond the positive electrode plate and a thickness H1 of the separation layer between the positive electrode plate and the negative electrode plate are controlled to be different and satisfy the following relationship with a thickness Hc of the positive electrode plate: (H2−H1)/Hc=½.

A difference between Example 11 and Example 10 lies in that (H2−H1)/Hc is controlled to be equal to 1.

A difference between Example 12 and Example 10 lies in that (H2−H1)/Hc is controlled to be equal to 3/2.

A difference between Example 13 and Example 12 lies in: When preparing the separation layer, 95% polyvinylidene fluoride, 4.5% acrylonitrile, and 0.5% boron trifluoride are dispersed in a solvent in which a weight ratio of dimethylformamide to acetone is 7:3, and the slurry is evenly stirred until a viscosity is stable, to obtain a solution A with a mass fraction of 25%. 95% aluminum oxide (with a particle size of 500 μm), 4.5% acrylonitrile, and 0.5% boron trifluoride are dispersed in a solvent in which a weight ratio of dimethylformamide to acetone is 7:3, and the slurry is evenly stirred until a viscosity is stable, to obtain a suspension B with a mass fraction of 40%. On a surface of the negative electrode plate, a polymer fiber layer filled with aluminum oxide particles is prepared by using the solutions A and B as raw materials through an electrospinning process and a solution blow spinning process respectively. A particle filling ratio is 4 wt. %.

A difference between Example 14 and Example 13 lies in that the particle filling ratio is controlled to be 10 wt. %.

A difference between Example 15 and Example 5 lies in that the particle filling ratio is controlled to be 50 wt. %.

A difference between Example 16 and Example 5 lies in that the particle filling ratio is controlled to be 80 wt. %.

A difference between Example 17 and Example 5 lies in that the particle filling ratio is controlled to be 90 wt. %.

A difference between Example 18 and Example 5 lies in that the particle filling ratio is controlled to be 95 wt. %.

A difference between Example 19 and Example 16 lies in that a spinning diameter is controlled to be 10 nm.

A difference between Example 20 and Example 16 lies in that a spinning diameter is controlled to be 50 nm.

A difference between Example 21 and Example 16 lies in that a spinning diameter is controlled to be 500 nm.

A difference between Example 22 and Example 16 lies in that a spinning diameter is controlled to be 2000 nm.

A difference between Example 23 and Example 16 lies in that a spinning diameter is controlled to be 5000 nm.

A difference between Example 24 and Example 21 lies in that a particle size of particles is controlled to be 10 nm.

A difference between Example 25 and Example 21 lies in that a particle size of particles is controlled to be 30 nm.

A difference between Example 26 and Example 21 lies in that a particle size of particles is controlled to be 800 nm.

A difference between Example 27 and Example 21 lies in that a particle size of particles is controlled to be 1000 nm.

A difference between Example 28 and Example 21 lies in that a particle size of particles is controlled to be 10000 nm.

A difference between Example 29 and Example 1 lies in that the polymer fibers are controlled to be polyethylene oxide.

A difference between Example 30 and Example 29 lies in that the polymer fibers are controlled to be polyimide (PI) and polyvinylidene fluoride (PVDF).

A difference between Example 31 and Example 21 lies in that the electrode assembly is in a stacked structure.

A difference between Comparative Example 1 and Example 1 lies in that conventional polyethylene is used as a separation layer.

A difference between Comparative Example 2 and Example 1 lies in that PET (polyethylene terephthalate) is used as a separation layer.

A difference between Comparative Example 3 and Example 1 lies in that PET and inorganic particles are used as a separation layer.

A difference between Comparative Example 4 and Example 1 lies in that used polymer fibers are polyimide (PI).

Test Method

Adhesion test: An electrode plate (including separation layers on two surfaces) was cut into a strip with a width of 2 cm, the separation layers were peeled on two sides from a surface of the electrode plate, and a universal tensile machine was used to pull bonding areas of the separation layers apart at an angle of 180° at a uniform speed. Measured force was y (N). Adhesion F (N/m) was equal to y/0.02.

Cycling capacity retention rate and deformation rate test: A lithium-ion battery was charged at a constant current of 0.5C to a voltage of 4.4 V, then charged at a constant voltage of 4.4 V to a current of 0.05C, and then discharged at a constant current of 1C to a voltage of 3.0 V. This was one charge-discharge cycle. A discharge capacity of the first cycle was recorded, 50 charge and discharge cycles were repeatedly performed, and the discharge capacity of the 50th cycle was recorded:

Cycling capacity retention rate=discharge capacity of the 50th cycle/discharge capacity of the first cycle.

After the lithium-ion battery completed the first charge and discharge cycle in the foregoing manner and was then charged to half of its capacity, a battery thicknesses in a regular area and an irregular area of the lithium-ion battery was measured, and each area was taken three points and recorded thickness data H0. After the lithium-ion battery was tested for 300 charge and discharge cycles and was then charged to half of its capacity, the same measuring position was selected, a same measuring tool was used to measure a thickness of the lithium-ion battery, and data H was recorded. A deformation rate of each measuring position was calculated by using the following expression:

Deformation rate of a measuring position=(H−H0)/H0×100%.

Then calculation results of different positions were averages to obtain a deformation rate of the lithium-ion battery.

Rate capability test: A lithium-ion battery was charged to a voltage of 4.4 V at a constant current of 0.5C, then charged to a current of 0.05C at a constant voltage of 4.4 V, and then discharged to a voltage of 3.0 V at a constant current of 1C, and a discharge capacity during the discharge at 1C was recorded. Then the lithium-ion battery was charged to a voltage of 4.4 V at a constant current of 0.5C, then charged to a current of 0.05C at a constant voltage of 4.4 V, and then discharged to a voltage of 3.0 V at a constant current of 3C, and a discharge capacity during the discharge at 3C was recorded, where rate capability=discharge capacity during discharge at 3C/discharge capacity during discharge at 1C×100%.

Drop test: Ten lithium-ion batteries were taken for the drop test, and a quantity of lithium-ion batteries that passed the test was recorded, where drop test pass rate=quantity of lithium-ion batteries that pass the test/10.

### Structural Parameters and Performance Test Results of Examples 1 to 31 and Comparative Examples 1 to 4 are Shown in the Following Table

| | | | Length | | | | Particle | |
|---|---|---|---|---|---|---|---|---|
| | | Width of | ratio of | | | Diameter | size of | |
| | Polymer | bonding | bonding | | content of | of spinning | inorganic | Porosity of |
| | material | area | areas | | inorganic | layer | material | separation |
| | type | W (mm) | L1/L2 | (H2 − H1)/Hc | material | (nm) | (nm) | layer |
| Comparative | PE | — | — | — | — | — | — | 40% |
| Example 1 | | | | | | | | |
| Comparative | PET | — | — | — | — | — | — | 40% |
| Example 2 | | | | | | | | |
| Comparative | PET | — | — | — | 95% | — | 500 | 40% |
| Example 3 | | | | | | | | |
| Comparative | PI | — | — | — | — | 500 | — | 42% |
| Example 4 | | | | | | | | |
| Example 1 | PVDF | 0.5 | 10% | — | | 500 | — | 42% |
| Example 2 | PVDF | 0.5 | 50% | — | | 500 | — | 42% |
| Example 3 | PVDF | 0.5 | 75% | — | | 500 | — | 42% |
| Example 4 | PVDF | 0.5 | 100% | — | | 500 | — | 42% |
| Example 5 | PVDF | 0.7 | 50% | — | | 500 | — | 42% |
| Example 6 | PVDF | 1 | 50% | — | | 500 | — | 42% |
| Example 7 | PVDF | 5 | 50% | — | | 500 | — | 42% |
| Example 8 | PVDF | 10 | 50% | — | | 500 | — | 42% |
| Example 9 | PVDF | 15 | 50% | — | | 500 | — | 42% |
| Example 10 | PVDF | 0.7 | 50% | 1/2 | — | 100 | — | 55% |
| Example 11 | PVDF | 0.7 | 50% | 1 | — | 100 | — | 55% |
| Example 12 | PVDF | 0.7 | 50% | 3/2 | — | 100 | — | 55% |
| Example 13 | PVDF | 0.7 | 50% | 3/2 | 4% | 100 | 500 | 55% |
| Example 14 | PVDF | 0.7 | 50% | 3/2 | 10% | 100 | 500 | 50% |
| Example 15 | PVDF | 0.7 | 50% | — | 50% | 100 | 500 | 45% |
| Example 16 | PVDF | 0.7 | 50% | — | 80% | 100 | 500 | 40% |
| Example 17 | PVDF | 0.7 | 50% | — | 90% | 100 | 500 | 35% |
| Example 18 | PVDF | 0.7 | 50% | — | 95% | 100 | 500 | 30% |
| Example 19 | PVDF | 0.7 | 50% | — | 80% | 10 | 500 | 30 |
| Example 20 | PVDF | 0.7 | 50% | — | 80% | 50 | 500 | 42% |
| Example 21 | PVDF | 0.7 | 50% | — | 80% | 500 | 500 | 42% |
| Example 22 | PVDF | 0.7 | 50% | — | 80% | 2000 | 500 | 38% |
| Example 23 | PVDF | 0.7 | 50% | — | 80% | 5000 | 500 | 35% |
| Example 24 | PVDF | 0.7 | 50% | — | 80% | 500 | 10 | 35% |
| Example 25 | PVDF | 0.7 | 50% | — | 80% | 500 | 30 | 35.50% |
| Example 26 | PVDF | 0.7 | 50% | — | 80% | 500 | 800 | 38% |
| Example 27 | PVDF | 0.7 | 50% | — | 80% | 500 | 1000 | 35% |
| Example 28 | PVDF | 0.7 | 50% | — | 80% | 500 | 10000 | 30% |
| Example 29 | PEO | 0.7 | 50% | — | 80% | 500 | — | 40% |
| Example 30 | PI + PVDF | 0.7 | 50% | — | 80% | 500 | — | 42% |
| Example 31 | PVDF | 0.7 | 50% | — | 80% | 500 | 500 | 55% |

| | | | | | | Cycling |
|---|---|---|---|---|---|---|
| | | | | | | capacity |
| | Adhesion | Adhesion | Drop test | Deformation | Rate | retention |
| | F1 (N/m) | F2 (N/m) | pass rate | rate (%) | capability | rate |
| Comparative | 0 | 0 | 0/10 | 6% | 65% | 95.5% |
| Example 1 | | | | | | |
| Comparative | 0 | 0 | 0/10 | 6% | 60% | 90% |
| Example 2 | | | | | | |
| Comparative | 0 | 0 | 0/10 | 6% | 62% | 92% |
| Example 3 | | | | | | |
| Comparative | 2 | 0 | 2/10 | 5% | 70% | 90% |
| Example 4 | | | | | | |
| Example 1 | 7 | 0 | 5/10 | 4% | 72% | 93.5% |
| Example 2 | 7 | 0 | 7/10 | 3% | 75% | 94% |
| Example 3 | 7 | 0 | 9/10 | 2% | 77% | 94.5% |
| Example 4 | 7 | 0 | 10/10 | 3% | 78% | 95% |
| Example 5 | 7 | 0 | 8/10 | 2% | 76% | 94.5% |
| Example 6 | 7 | 0 | 10/10 | 2% | 78% | 94.8% |
| Example 7 | 10 | 0 | 10/10 | 2% | 79% | 95.2% |
| Example 8 | 10 | 0 | 10/10 | 2% | 80% | 95% |
| Example 9 | 10 | 0 | 10/10 | 2% | 79% | 94.4% |
| Example 10 | 7 | 0.5 | 10/10 | 1% | 78% | 95% |
| Example 11 | 6 | 1 | 10/10 | 1% | 80% | 95.5% |
| Example 12 | 5 | 2 | 10/10 | 1% | 79% | 95.3% |
| Example 13 | 7 | 2 | 10/10 | 1% | 77% | 94.2% |
| Example 14 | 7 | 2 | 10/10 | 1% | 74% | 94% |
| Example 15 | 6 | 0 | 10/10 | 3% | 75% | 94% |
| Example 16 | 6 | 0 | 9/10 | 3% | 74% | 93.5% |
| Example 17 | 6 | 0 | 9/10 | 4% | 72% | 93% |
| Example 18 | 5 | 0 | 8/10 | 4% | 72% | 93% |
| Example 19 | 6 | 0 | 10/10 | 2% | 72% | 92% |
| Example 20 | 7 | 0 | 10/10 | 2% | 73% | 93% |
| Example 21 | 6 | 0 | 10/10 | 3% | 72% | 94.5% |
| Example 22 | 5 | 0 | 7/10 | 4% | 72% | 93.5% |
| Example 23 | 5 | 0 | 8/10 | 4% | 70% | 92% |
| Example 24 | 5 | 0 | 8/10 | 4% | 65% | 92% |
| Example 25 | 5 | 0 | 9/10 | 3% | 65% | 92% |
| Example 26 | 5 | 0 | 10/10 | 3% | 70% | 92.5% |
| Example 27 | 5 | 0 | 10/10 | 3% | 65% | 92% |
| Example 28 | 5 | 0 | 8/10 | 3% | 65% | 91% |
| Example 29 | 5 | 0 | 9/10 | 2% | 72% | 93.5% |
| Example 30 | 5 | 0 | 10/10 | 2% | 73% | 94.5% |
| Example 31 | 5 | 0 | 9/10 | 1% | 75% | 94.5% |

“—” means no addition or not having such property.

The results show that, compared with conventional separation layers (Comparative Examples 1 to 3), the electrochemical apparatus in the embodiments of this application has the following characteristics: Deformation of the lithium-ion battery can be suppressed, and drop safety performance is improved.

Compared with Comparative Example 4, the electrochemical apparatus in the embodiments of this application has the following characteristics: By adjusting the adhesion F1 to be greater than or equal to 5 N/m, drop safety of the lithium-ion battery is greatly improved.

It can be learned from the comparison of Examples 1 to 9 that, when a spinning diameter and a porosity of a fiber layer remain the same, a length ratio and a width of a bonding area of the fiber layer may be adjusted to further improve safety performance of the lithium-ion battery. Examples 2 to 4 in which L1/L2≥0.5 and Examples 6 to 9 in which W≥1 mm have higher drop test pass rates. This is because edges of a fiber layer meeting the foregoing conditions are less likely to be damaged, and under impact of external force, a possibility that a separation layer turns outward or powder falls of an electrode plate is lower, so the risk of failure of the lithium-ion battery is lower. In addition, an increase in the bonding area of the fiber layer can also increase a liquid retention capacity of the battery and improve ion conduction efficiency of the battery, thereby achieving a higher rate capability and a higher cycling capacity retention rate.

In addition, it can be learned from the comparison between Examples 10 to 12 and Example 5 that, by controlling a thickness difference between separation layers, a third bonding area is bonded to a fourth bonding area, thereby further reducing a deformation rate and improving drop safety.

In addition, by controlling the spinning diameter and filling particles, a differentiated design can be implemented for adhesion and strength of the fiber layer. This can improve stiffness of the lithium-ion battery and further improve cycling performance. Moreover, this can further improve self-discharge resistance, thereby improving overall performance of the lithium-ion battery.

The foregoing descriptions are merely some embodiments of this application, but are not intended to limit the patent scope of this application. Any equivalent structural transformations made by using the content of the specification and drawings are included in the patent protection scope of this application in the same way.

What is claimed is:

1. An electrochemical apparatus, comprising: an electrode assembly; wherein the electrode assembly comprises a first electrode plate, a first separation layer, a second electrode plate, and a second separation layer; the first separation layer is located between the first electrode plate and the second electrode plate, and the second electrode plate is located between the first separation layer and the second separation layer; along a first direction, the first separation layer comprises a first protruding portion extending beyond the second electrode plate, and the second separation layer comprises a second protruding portion extending beyond the second electrode plate; and the first protruding portion comprises a first bonding area, the second protruding portion comprises a second bonding area, and adhesion between the first bonding area and the second bonding area is F1, wherein F1≥5 N/m.

2. The electrochemical apparatus according to claim 1, wherein along a second direction perpendicular to the first direction, a length of the first bonding area is L1, and a length of the first protruding portion is L2, wherein 0.1≤L1/L2≤1.

3. The electrochemical apparatus according to claim 1, wherein along a second direction perpendicular to the first direction, a length of the first bonding area is L1, and a length of the first protruding portion is L2, wherein 0.5≤L1/L2≤0.75.

4. The electrochemical apparatus according to claim 2, wherein a width of the first bonding area is 0.5 mm to 20 mm.

5. The electrochemical apparatus according to claim 2, wherein a width of the first bonding area is 0.5 mm to 2 mm.

6. The electrochemical apparatus according to claim 1, wherein one of the following conditions is satisfied:
(i) the electrode assembly is in a stacked structure, and the electrode assembly further comprises a third separation layer and a third electrode plate, wherein the second separation layer is located between the second electrode plate and the third electrode plate, and the third electrode plate is located between the second separation layer and the third separation layer; and along the first direction, the third separation layer comprises a third protruding portion extending beyond the third electrode plate, the second separation layer comprises a fourth protruding portion extending beyond the third electrode plate, the third protruding portion comprises a third bonding area, and the fourth protruding portion comprises a fourth bonding area, wherein the third bonding area is bonded with the fourth bonding area; and
(ii) the electrode assembly is in a wound structure; along a winding thickness direction of the electrode assembly, the first electrode plate comprises a first layer portion and a third layer portion that are adjacent to each other, the second electrode plate comprises a second layer portion and a fourth layer portion that are adjacent to each other, the first separation layer comprises a first separation portion and a third separation portion that are adjacent to each other, the second separation layer comprises a second separation portion and a fourth separation portion that are adjacent to each other; and the first layer portion, the first separation portion, the second layer portion, the second separation portion, the third layer portion, the third separation portion, the fourth layer portion, and the fourth separation portion are arranged in order; and along the first direction, the third separation portion comprises a third protruding portion extending beyond the third layer portion, the second separation portion comprises a fourth protruding portion extending beyond the third layer portion, the third protruding portion comprises a third bonding area, and the fourth protruding portion comprises a fourth bonding area, wherein the third bonding area is bonded with the fourth bonding area.

7. The electrochemical apparatus according to claim 6, wherein adhesion between the third bonding area and the fourth bonding area is F2, wherein F2<5 N/m.

8. The electrochemical apparatus according to claim 6, wherein adhesion between the third bonding area and the fourth bonding area is F2, wherein F2≤2 N/m.

9. The electrochemical apparatus according to claim 6, wherein the first electrode plate and the third electrode plate are positive electrode plates, and the second electrode plate is a negative electrode plate.

10. The electrochemical apparatus according to claim 9, wherein along the first direction, the second electrode plate comprises a first structural portion extending beyond the third electrode plate, and the fourth bonding area is located on a surface of the first structural portion; or along the first direction, the second layer portion comprises a first structural portion extending beyond the third layer portion, and the fourth bonding area is located on a surface of the first structural portion.

11. The electrochemical apparatus according to claim 10, wherein along the first direction, the second separation layer comprises a first area located on a surface of the third electrode plate and a second area located on the surface of the first structural portion, a thickness of the first area is H1, a thickness of the second area is H2, and a thickness of the third electrode plate is H3, wherein ½≤(H2−H1)/H3≤3/2; or along the first direction, the second separation portion comprises a first area located on a surface of a third layer portion, and a second area located on the surface of the first structural portion, a thickness of the first area is H1, a thickness of the second area is H2, and a thickness of the third layer portion is H3, wherein ½≤(H2−H1)/H3≤3/2.

12. The electrochemical apparatus according to claim 6, wherein a porosity of each of the first separation layer, the second separation layer, and the third separation layer is independently α, an aperture of each is independently Φ, a thickness of each is independently H, and at least one of the following conditions is satisfied:
30%≤α≤95%; (a)
10 nm≤Φ≤5 μm; or (b)
1 μm≤H≤20 μm. (c)

13. The electrochemical apparatus according to claim 6, wherein at least one of the first separation layer, the second separation layer, and the third separation layer comprises polymer fibers, and further particles, wherein the particles comprise at least one of inorganic substance or organic substance.

14. The electrochemical apparatus according to claim 13, wherein at least one of the first separation layer, the second separation layer, and the third separation layer comprises a first layer and a second layer disposed on the first layer, wherein the first layer comprises the polymer fibers, and the second layer comprises the particles.

15. The electrochemical apparatus according to claim 13, wherein
the polymer fibers comprise at least one of polyvinylidene fluoride, polyimide, polyamide, polyacrylonitrile, polyethylene glycol, polyethylene oxide, polyphenylene oxide, polypropylene carbonate, polymethyl methacrylate, polyethylene glycol terephthalate, poly(vinylidene fluoride-hexafluoropropylene), poly(vinylidene fluoride-chlorotrifluoroethylene), or derivatives thereof;
the inorganic substance comprises at least one of hafnium oxide, strontium titanate, tin dioxide, cesium oxide, magnesium oxide, nickel oxide, calcium oxide, barium oxide, zinc oxide, zirconium oxide, yttrium oxide, aluminum oxide, titanium oxide, silicon dioxide, alumina hydrate, magnesium hydroxide, aluminum hydroxide, lithium phosphate, lithium titanium phosphate, lithium aluminum titanium phosphate, lithium lanthanum titanate, lithium germanium thiophosphate, lithium nitride, SiS₂ glass, P₂S₅ glass, lithium oxide, lithium fluoride, lithium hydroxide, lithium carbonate, lithium metaaluminate, lithium germanium phosphorous sulfur ceramics, or garnet ceramics; and
the organic substance comprises at least one of polyvinylidene fluoride, polyimide, polyamide, polyacrylonitrile, polyethylene glycol, polyethylene oxide, polyphenylene oxide, polypropylene carbonate, polymethyl methacrylate, polyethylene glycol terephthalate, poly(vinylidene fluoride-hexafluoropropylene), poly(vinylidene fluoride-chlorotrifluoroethylene), or derivatives thereof.

16. An electrical device, comprising an electrochemical apparatus, wherein the electrochemical apparatus comprises an electrode assembly, wherein the electrode assembly comprises a first electrode plate, a first separation layer, a second electrode plate, and a second separation layer, the first separation layer is located between the first electrode plate and the second electrode plate, and the second electrode plate is located between the first separation layer and the second separation layer; along a first direction, the first separation layer comprises a first protruding portion extending beyond the second electrode plate, and the second separation layer comprises a second protruding portion extending beyond the second electrode plate; and the first protruding portion comprises a first bonding area, the second protruding portion comprises a second bonding area, and adhesion between the first bonding area and the second bonding area is F1, wherein F1≥5 N/m.

17. The electrical device according to claim 16, wherein along a second direction perpendicular to the first direction, a length of the first bonding area is L1, and a length of the first protruding portion is L2, wherein 0.1≤L1/L2≤1.

18. The electrical device according to claim 16, wherein one of the following conditions is satisfied:
(1) the electrode assembly is in a stacked structure, and the electrode assembly further comprises a third separation layer and a third electrode plate, wherein the second separation layer is located between the second electrode plate and the third electrode plate, and the third electrode plate is located between the second separation layer and the third separation layer; and along the first direction, the third separation layer comprises a third protruding portion extending beyond the third electrode plate, the second separation layer comprises a fourth protruding portion extending beyond the third electrode plate, the third protruding portion comprises a third bonding area, and the fourth protruding portion comprises a fourth bonding area, wherein the third bonding area is bonded with the fourth bonding area; and
(2) the electrode assembly is in a wound structure; along a winding thickness direction of the electrode assembly, the first electrode plate comprises a first layer portion and a third layer portion that are adjacent to each other, the second electrode plate comprises a second layer portion and a fourth layer portion that are adjacent to each other, the first separation layer comprises a first separation portion and a third separation portion that are adjacent to each other, the second separation layer comprises a second separation portion and a fourth separation portion that are adjacent to each other; and the first layer portion, the first separation portion, the second layer portion, the second separation portion, the third layer portion, the third separation portion, the fourth layer portion, and the fourth separation portion are arranged in order; and along the first direction, the third separation portion comprises a third protruding portion extending beyond the third layer portion, the second separation portion comprises a fourth protruding portion extending beyond the third layer portion, the third protruding portion comprises a third bonding area, and the fourth protruding portion comprises a fourth bonding area, wherein the third bonding area is bonded with the fourth bonding area.

19. The electrical device according to claim 18, wherein adhesion between the third bonding area and the fourth bonding area is F2, wherein F2<5 N/m.

20. The electrical device according to claim 18, wherein the first electrode plate and the third electrode plate are positive electrode plates, and the second electrode plate is a negative electrode plate.
